(19) United States
(12) Patent Application Publication
(10) Pub. No.: US 2024/0320518 A1
(43) Pub. Date: Sep. 26, 2024

(54) SYSTEMS AND METHODS FOR AUTOMATICALLY CONSTRUCTING KNOWLEDGE GRAPHS

(71) Applicant: The Florida State University Research Foundation, Inc., Tallahassee, FL (US)

(72) Inventor: Mikhail Gubanov, Tallahassee, FL (US)

(21) Appl. No.: 18/612,359

(22) Filed: Mar. 21, 2024

Related U.S. Application Data
(60) Provisional application No. 63/491,404, filed on Mar. 21, 2023.

(51) Int. Cl. G06N 5/02

(52) U.S. Cl. CPC G06N 5/02

(57) ABSTRACT

Described herein are systems and methods providing online, interactive, trustworthy knowledge graphs for a specific topic (e.g., COVID-19) and search engines using such knowledge graphs. In some aspects, a method for automatically constructing knowledge graphs includes: accessing a dataset, the dataset including a plurality of articles related to a specific topic; classifying, using a first artificial intelligence (AI) model, a plurality of tables within the dataset; classifying, using a second AI model, a plurality of hierarchal metadata of the tables; and fusing, using a third AI model, the hierarchal metadata into a knowledge graph, the knowledge graph being associated with the specific topic.

### CROSS-REFERENCE TO RELATED APPLICATION

This application claims priority to, and the benefit of, U.S. Provisional Patent Application No. 63/491,404, filed Mar. 21, 2023, entitled “SYSTEMS AND METHODS FOR AUTOMATICALLY CONSTRUCTING KNOWLEDGE GRAPHS,” which is incorporated by reference herein in its entirety.

### STATEMENT REGARDING FEDERALLY FUNDED RESEARCH

This invention was made with government support under Grant no. 2229256 awarded by the National Science Foundation. The government has certain rights in the invention.

### BACKGROUND

Published medical knowledge doubles every 73 days, which makes prompt access to the latest, trustworthy, medical findings very challenging for both the general public and medical professionals. This problem was especially noticeable during the pandemic, when all popular, previously trusted sources—the Web, social media, News Media suddenly became full of biased opinions and misinformation. Such remarkable information “decay” was fueled by both the severity of the problem and desperate need for trustworthy information in order to survive. At the same time, the current lack of a viable technology for collecting and conveniently accessing all up-to-date trusted medical knowledge, results in time-consuming Google/PubMed/QxMD/other search, aggravated by the need to read hundreds of returned Webpages, publications, which is prohibitively slow and usually still does not have the up-to-date information indexed.

Thus, a solution for providing access to the latest, trustworthy, medical findings is desirable.

### SUMMARY

Described herein are systems and methods providing online, interactive, trustworthy knowledge graphs for a specific topic (e.g., COVID-19) and search engines using such knowledge graphs. The knowledge graph's contents are automatically extracted from the latest peer-reviewed literature and fused to the knowledge graph using artificial intelligence models.

In some aspects, the techniques described herein relate to a method for automatically constructing knowledge graphs including: accessing a dataset, the dataset including a plurality of articles related to a specific topic; classifying, using a first artificial intelligence (AI) model, a plurality of tables within the dataset; classifying, using a second AI model, a plurality of hierarchal metadata of the tables; and fusing, using a third AI model, the hierarchal metadata into a knowledge graph, the knowledge graph being associated with the specific topic.

In some aspects, the method further includes analyzing the dataset to parse and store content in a semi-structured format.

In some aspects, the method further includes preprocessing the tables to encode numerical data within the tables.

In some aspects, the method further includes constructing a plurality of feature vectors for each of a plurality of rows within the tables.

In some aspects, the method further includes clustering, using a fourth AI model, the tables into a plurality of sub-topics associated with the specific topic.

In some aspects, the method further includes initializing a structural hierarchy of the knowledge graph.

In some aspects, the articles are peer-reviewed articles.

In some aspects, the specific topic is COVID-19.

In some aspects, the first AI model is a recurrent neural network (RNN), the second AI model is a support vector machine (SVM), and the third AI model is a natural language processing (NLP) model.

In some aspects, the techniques described herein relate to a method for providing a search engine including: providing the knowledge graph as describe above; and providing a user interface for interrogating the knowledge graph.

In some aspects, the method further includes receiving a user query at the user interface and displaying search results on the user interface.

In some aspects, the techniques described herein relate to a system for automatically constructing knowledge graphs including: a computing cluster including a plurality of computing devices, each computing device including at least one processor and a memory operably coupled to the at least one processor; a database operably coupled to the computing cluster, wherein the database stores a dataset including a plurality of articles related to a specific topic, wherein the computing cluster is configured to: access the dataset; classify, using a first artificial intelligence (AI) model, a plurality of tables within the dataset; classify, using a second AI model, a plurality of hierarchal metadata of the tables; and fuse, using a third AI model, the hierarchal metadata into a knowledge graph, the knowledge graph being associated with the specific topic.

In some aspects, the techniques described herein relate to a system for automatically constructing knowledge graphs including: a computing cluster including a plurality of computing devices, each computing device including at least one processor and a memory operably coupled to the at least one processor; a database operably coupled to the computing cluster, wherein the database stores a dataset including a plurality of articles related to a specific topic, wherein the computing cluster is configured to: access the dataset; classify, using a first artificial intelligence (AI) model, a plurality of tables within the dataset; classify, using a second AI model, a plurality of hierarchal metadata of the tables; and fuse, using a third AI model, the hierarchal metadata into a knowledge graph, the knowledge graph being associated with the specific topic.

In some aspects, the computing cluster is further configured to analyze the dataset to parse and store content in a semi-structured format.

In some aspects, the computing cluster is further configured to preprocess the tables to encode numerical data within the tables.

In some aspects, the computing cluster is further configured to construct a plurality of feature vectors for each of a plurality of rows within the tables.

In some aspects, the computing cluster is further configured to cluster, using a fourth AI model, the tables into a plurality of sub-topics associated with the specific topic.

In some aspects, the computing cluster is further configured to initialize a structural hierarchy of the knowledge graph.

In some aspects, the articles are peer-reviewed articles.

In some aspects, the specific topic is COVID-19.

In some aspects, the first AI model is a recurrent neural network (RNN), the second AI model is a support vector machine (SVM), and the third AI model is a natural language processing (NLP) model.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a diagram of an environment for automatically constructing knowledge graphs according to an implementation described herein.

FIG. 2 is a flow diagram illustrating example operations for automatically constructing knowledge graphs according to example implementations described herein.

FIG. 3 is an example computing device.

FIG. 4 is a snapshot of COVIDKG.org advanced publication search-engine interface.

FIG. 5 is a diagram of deep-learning BiGRU architecture with parallel term- and cell-level embedding layers.

FIG. 6 is a snapshot of COVIDKG.org advanced table search-engine interface.

FIG. 7 is a diagram of the back-end architecture.

FIG. 8 is graph of meta-profiles for COVID-19 vaccination side-effects, extracted from tables in three papers, grouped by vaccine, dosage, and paper.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “about” or “approximately” when referring to a measurable value such as an amount, a percentage, and the like, is meant to encompass variations of +20%, +10%, +5%, or +1% from the measurable value.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or targets) during training with both labeled and unlabeled data.

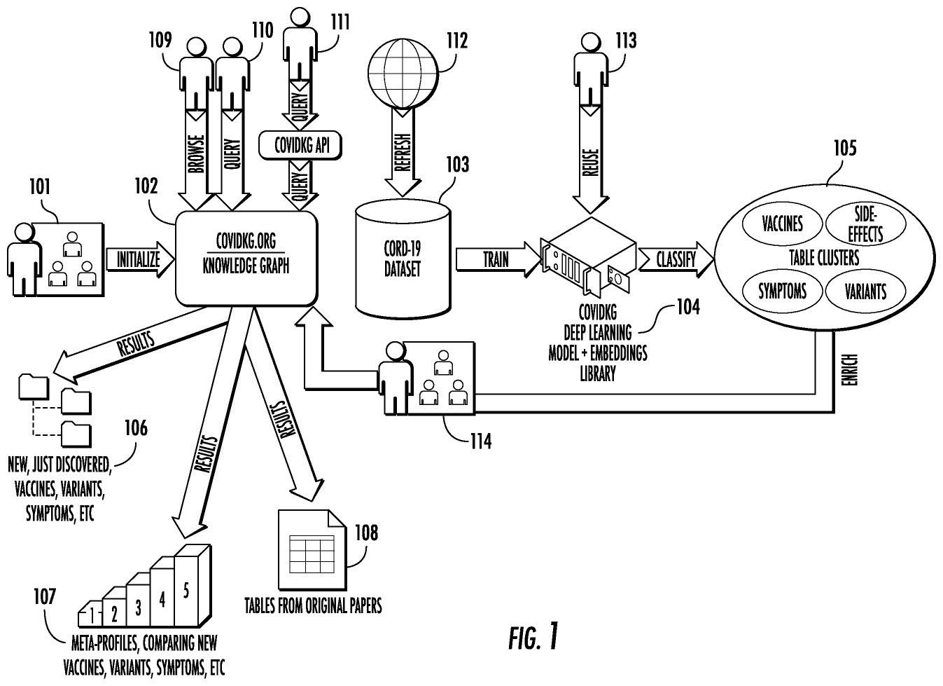

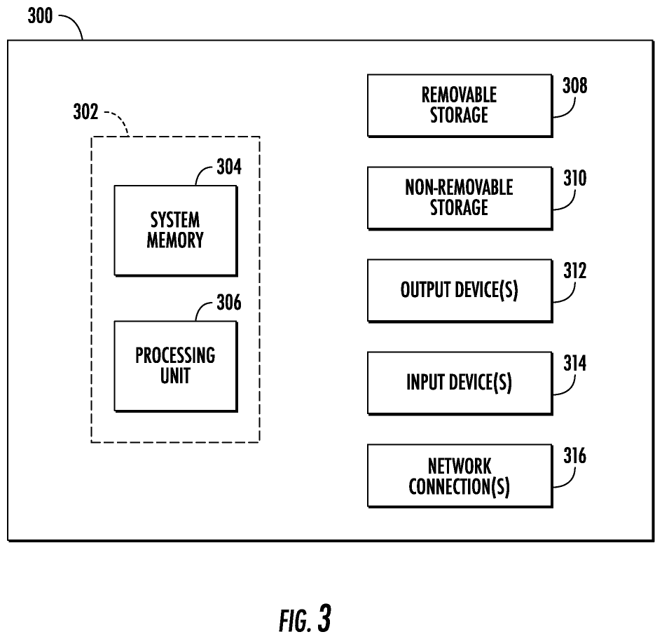

Referring now to FIG. 1, a diagram of an environment for automatically constructing knowledge graphs is shown. An example system can include a computing cluster (e.g., 104 in FIG. 1) including a plurality of computing devices. Each of the computing device includes at least one processor and a memory operably coupled to the at least one processor (e.g., the basic configuration of box 302 in FIG. 3). Additionally, the system can include a database (e.g., the sharded MongoDB described below with regard to FIG. 1) operably coupled to the computing cluster 104. The database stores a dataset (e.g., 103 in FIG. 1) including a plurality of articles related to a specific topic.

As shown in FIG. 1, a Medical Engineering professional 101 who creates an initial, small (10-20 nodes) structural layout that will initialize the base of the Knowledge Graph is shown. The current Knowledge Graph 102, stored in a database, e.g., a scalable sharded MongoDB storage is also shown. The CORD-19 dataset 103, parsed, processed by the trained Deep-learning models, and also stored in a sharded MongoDB is also shown. A high-performance computing cluster 104, e.g., Nvidia GPU A100 cluster, responsible for training and classification workloads of the Deep-Learning models and custom tabular embeddings is also shown. The topical clusters of tables 105 that are categorized from the dataset by relevant COVID-19 topics are also shown. Newly discovered vaccines, strains, side-effects 106 extracted by the Deep-Learning models from the dataset later fused with the Knowledge Graph is also shown. The Deep learning models 107, learning the multi-layered 3D Meta-profiles, summarizing and visualizing knowledge from several sources is also shown. The extracted tables 108 from medical COVID-19 papers. Tables usually have the main results from the paper, so tables are a valuable source of information for the Knowledge Graph is also shown. Users 109, 110 who browse the Knowledge Graph by clicking nodes and using the interactive features or query the custom search engines are also shown. The COVIDKG API users 111, 113 that might want to query the Knowledge Graph or fine-tune and reuse the released, pre-trained Deep-learning models or Embeddings on their own dataset are also shown. The World Wide Web 112 with new information on COVID-19 updated frequently in CORD-19 that is being ingested and further analyzed by the architecture. Any new publications will be crawled and ingested into the dataset is also shown. The fusion of sub-trees 114 having several layers or addition of new nodes that may be evaluated by a human expert before it gets fused with the Knowledge Graph. The architecture shown in FIG. 1 is referred to in the Examples as the COVIDKG architecture and is described in further detail in the Examples below.

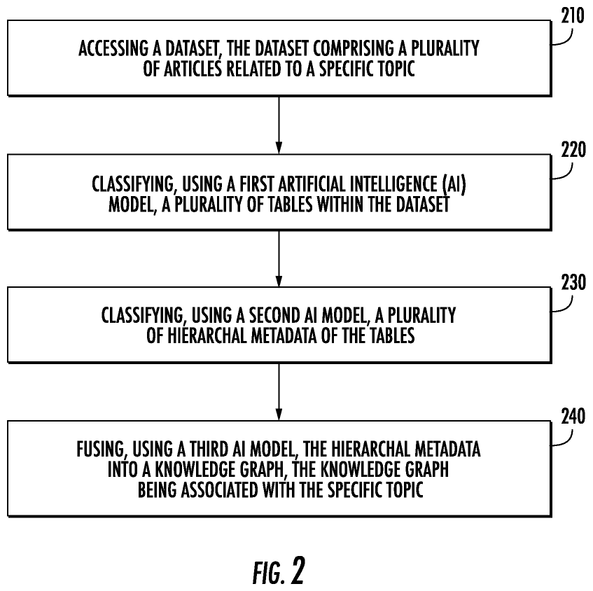

Referring now to FIG. 2, a flowchart of an example method for automatically constructing knowledge graphs is shown. It should be understood that the logical operations of FIG. 2 can be performed using the system described above with regard to FIG. 1.

At step 210, the method includes accessing a dataset, the dataset comprising a plurality of articles related to a specific topic. As described herein, the articles can be trustworthy articles, for example, peer-reviewed articles. Such articles may include open access publications such as those by major publishers PubMed, medRxiv, bioRxix, and arXiv. Additionally, the articles are related to a specific topic. As described herein, the specific topic is COVID-19. It should be understood that COVID-19 is provided only as an example topic. This disclosure contemplates that the specific topic may be other than COVID-19 including, but not limited to, scientific topics. An example dataset including articles related to COVID-19 is described in the Examples below.

At step 220, the method includes classifying, using a first artificial intelligence (AI) model, a plurality of tables within the dataset. Step 220 is described in the Examples below, for example, in sections of “Metadata Classification.” In this step, the first AI model is used to identify tables within the dataset. In other words, the first AI model is trained to classify information within text as a table or not a table. Tables classified by the first AI model are processed further as described below. In some implementations, the first AI model is a supervised machine learning model. Optionally, the first AI model is an artificial neural network. For example, the first AI model can be a deep learning model such as a recurrent neural network (RNN). An RNN is a class of artificial neural network where connections between nodes can create a cycle, allowing output from some nodes to affect subsequent input to the same nodes. The RNN has internal memory and can be used to analyze sequential or time series data. It should be understood that RNN is provided only as an example AI model. This disclosure contemplates that the first AI model may be a machine learning model such as an SVM, regression model, decision trees, ensemble, or deep learning model.

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan H, or rectified linear unit (ReLU) function), and provide an output in accordance with the activation function.

Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example AI model. This disclosure contemplates that the first AI model may be another supervised learning model, semi-supervised learning model, or unsupervised learning model. Additionally, in some implementations, the method further includes analyzing the dataset to parse and store content in a semi-structured format. It should be understood that the step of parsing and storing content can be performed prior to the step of classification at 220.

At step 230, the method includes classifying, using a second AI model, a plurality of hierarchal metadata of the tables. Step 230 is described in the Examples below, for example, in sections of “Metadata Classification.” In this step, the second AI model is used to identify multi-layer metadata (e.g., attributes) rows in the tables identified at step 220. In some implementations, the second AI model is a supervised learning model. Optionally, the second AI model is a support vector machine (SVM). An SVM is a supervised learning model that uses statistical learning frameworks to predict the probability of a target. This disclosure contemplates that the SVMs can be implemented using a computing device (e.g., a processing unit and memory as described herein). SVMs can be used for classification and regression tasks. SVMs are trained with a data set (also referred to herein as a “dataset”) to maximize or minimize an objective function, for example a measure of the SVM's performance, during training. SVMs are known in the art. It should be understood that SVM is provided only as an example AI model. This disclosure contemplates that the second AI model may be another supervised learning model, semi-supervised learning model, or unsupervised learning model. It should be understood that SVM is provided only as an example AI model. This disclosure contemplates that the second AI model may be a machine learning model such as an SVM, regression model, decision trees, ensemble, or deep learning model. Additionally, in some implementations, the method further includes preprocessing the tables to encode numerical data within the tables. Alternatively, or additionally, the method further includes constructing a plurality of feature vectors for each of a plurality of multi-layer metadata (e.g., attributes) rows within the tables that are identified at step 230. It should be understood that the steps of preprocessing and constructing feature vectors can be performed prior to the step of classification at 230.

At step 240, the method includes fusing, using a third AI model, the hierarchal metadata into a knowledge graph. Step 240 is described in the Examples below, for example, in the section, “Knowledge Graph.” The knowledge graph is associated with the specific topic (e.g., COVID-19 in the Examples). In this step, the third AI model is used to fuse the hierarchal metadata into the knowledge graph. Optionally, the third AI model is a natural language processing (NLP) model. NLP models are known in the art. Optionally, a structural hierarchy of the knowledge graph is initialized before performing step 240. Additionally, in some implementations, the method further includes clustering, using a fourth AI model, the tables into a plurality of sub-topics associated with the specific topic. The fourth AI model can be a machine learning model such as an SVM, regression model, decision trees, ensembles. Optionally, the fourth AI model can be a deep learning models such as a multi-layer perceptron, RNN, long short-term memory (LSTM) with embeddings such as Word2Vec, ELMo, BERT, etc. It should be understood that the step of clustering can be performed prior to the step of fusion at 240.

Accessing and classifying elements of scientific and medical publications, for example, searching recent publications for relevant COVID-19 data, becomes exceedingly time-consuming and un-yielding. As noted earlier, published medical knowledge doubles every 73 days, which creates a technical problem of timely and accurately cataloguing, classifying, and producing usable knowledge for end-users. Executing the method as shown in FIG. 2 addresses such problems by providing an on-demand solution to the expanding-knowledge problem, at least in the medical and scientific fields, where a significant portion of relevant data is presented in tables. For example, the method includes classifying, using a first AI model, a plurality of tables within a dataset (e.g. 220 of FIG. 2), and classifying, using a second AI model, the plurality of hierarchal metadata of the tables (e.g. 230 of FIG. 2). As a result, the method of FIG. 2 facilitates extraction of the structured information contained in tables found within the articles (e.g. valuable information). The method also includes fusing, using a third AI model, the hierarchal metadata into a knowledge graph (e.g., 240 of FIG. 2). The knowledge graph provides a searchable and browsable medium of the growing body medical and scientific knowledge on the world wide web. Additionally, as shown in FIG. 1, the dataset 103 including the plurality of articles can optionally be processed in the computing cluster 104, wherein a computing cluster includes several computing processors networked in parallel to compute large amounts of data that would otherwise overwhelm a single computer processor. The computing cluster 104 can be trained to classify the plurality of tables within the dataset (e.g. 220 of FIG. 2) and the plurality of hierarchal metadata of the tables (e.g. 230 of FIG. 2), thereby forming table clusters 105, which can be fused into a knowledge graph (e.g., 240 of FIG. 2).

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM), non-volatile (such as read-only memory (ROM), flash memory, etc.), or some combination of the two. This most basic configuration is illustrated in FIG. 3 by box 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

In some implementations, a computing device comprises graphical compute units (GPUs). A GPU is a processing chip comprised of a grid of compute cores. Compared to a conventional computer processing unit (CPU), GPUs increase the number of compute cores by decreasing the footprint (and size) of CACHE memory. The architecture of GPUs are configured to increase processing power and decrease the amount of and duration of data storage, which makes the GPU preferable for streamed data applications, such as rendering high frames-per-second video. A computing device may have both CPUs and GPUs or variations thereof.

In some implementations, a computing device, including a processing unit and memory, is connected to several similar computing devices, configured to operate in parallel, thereby forming a parallel computing cluster. The computing devices of a cluster are termed compute nodes. The cluster further includes one or more memory devices (storage) which are separate from compute nodes, and a central processing unit (CPU). The compute nodes and storage are connected by a network, which may be a hard-wired or remote network. In some examples, a cluster contains on the order of hundreds or thousands of compute nodes and high-capacity storage that are massively connected in parallel by a hardwired network. These massively parallel clusters are termed high-performance computing (HPC) clusters. HPC clusters operate with specialty software to allow the compute nodes, storage, and CPUs to work as a single machine. The arrangement of compute nodes and storage on a network may be any that allows for parallel networking and centralized control to be considered an HPC. In some examples, HPC compute nodes are a combination of CPUs and GPUs. Performance of HPCs are measured floating point operations per second (FLOP/s). A computer or HPC cluster that performs at in one billion (10⁹) FLOP/s (GLOP/s) is termed a supercomputer. In the 2010's, supercomputer performance increased first to petaflop (10¹⁵) scale and was later surpassed by exaflop (1018⁾ scale performance.

### Examples

The following examples are put forth so as to provide those of ordinary skill in the art with a complete disclosure and description of how the compounds, compositions, articles, devices and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in° C. or is at ambient temperature, and pressure is at or near atmospheric.

### Architecture:

A web-scale, interactive COVID-19 knowledge graph system, hereafter COVIDKG, was designed, validated and launched in response to investigations of public needs through conducting hundreds of interviews and customer discovery process [11].

The architecture of the COVIDKG system is demonstrated in FIG. 1. The architecture includes a representative Medical Engineering professional 101 who creates an initial, small (10-20 nodes) structural layout that initializes the base of the Knowledge Graph. The Knowledge Graph, (KG) 102, is stored in a scalable sharded MongoDB storage [9]. A dataset, the CORD-19 dataset 103, is parsed and processed by the trained Deep-learning models and also stored in a sharded MongoDB. A high-performance NVidia GPU cluster 104 is responsible for training and classification workloads of the Deep-Learning models and custom tabular embeddings and is configured with Apache Spark MLLib and TensorFlow [12]. The topical clusters 105 were categorized from the dataset by relevant COVID-19 topics. Newly discovered vaccines, strains, side-effects 106 were extracted by the Deep-Learning models from the dataset and later fused with the main KG. 107 corresponds to the Deep learning models, learning the multi-layered 3D Meta-profiles, summarizing and visualizing knowledge from several sources. 108 corresponds to the extracted tables from medical COVID-19 papers.

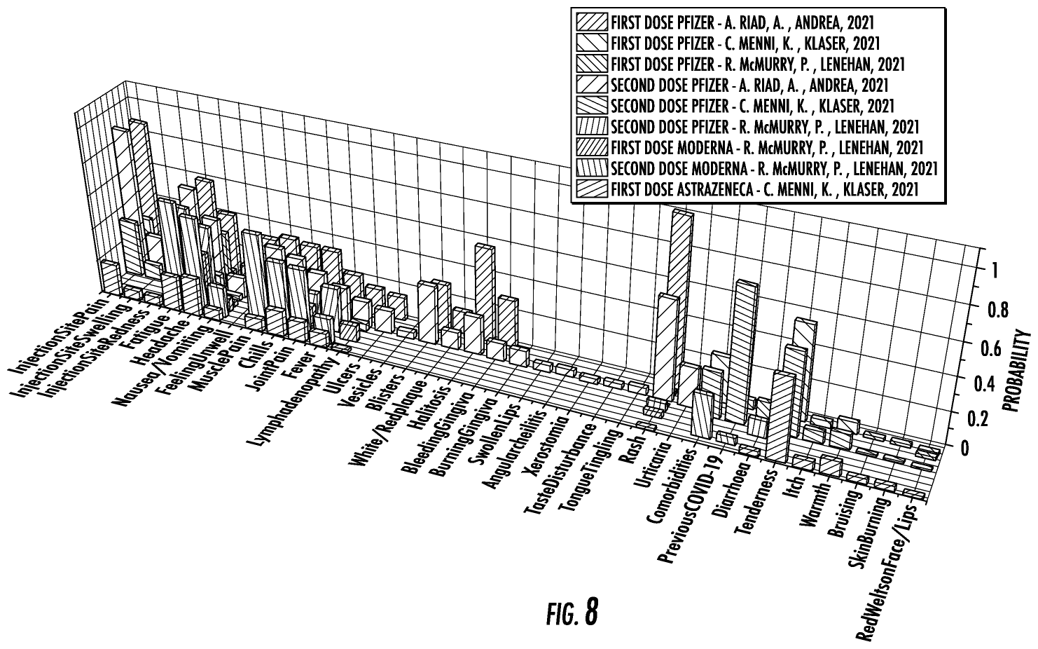

For example, FIG. 8 displays a multi-layered 3D profile for COVID-19 Vaccine Side effects composed from three different COVID-19 papers. The 3D visualization of FIG. 8 summarizes information from nine different sources in one place and is much easier to comprehend than reading these three papers and understanding all details about the vaccine side-effects.

Referring again to FIG. 1, the KG is browsed by users 109 by clicking nodes and using the interactive features or queried by users 110 using a custom search engines. COVIDKG API users 111, 113 can query the Knowledge Graph or fine-tune and reuse the released, pre-trained Deep-learning models or Embeddings on their own dataset. 112 depicts the World Wide Web with new information on COVID-19. 114 portrays the fusion of sub-trees having several layers or addition of new nodes that may have to be evaluated by a human expert before the fusion into the Knowledge Graph.

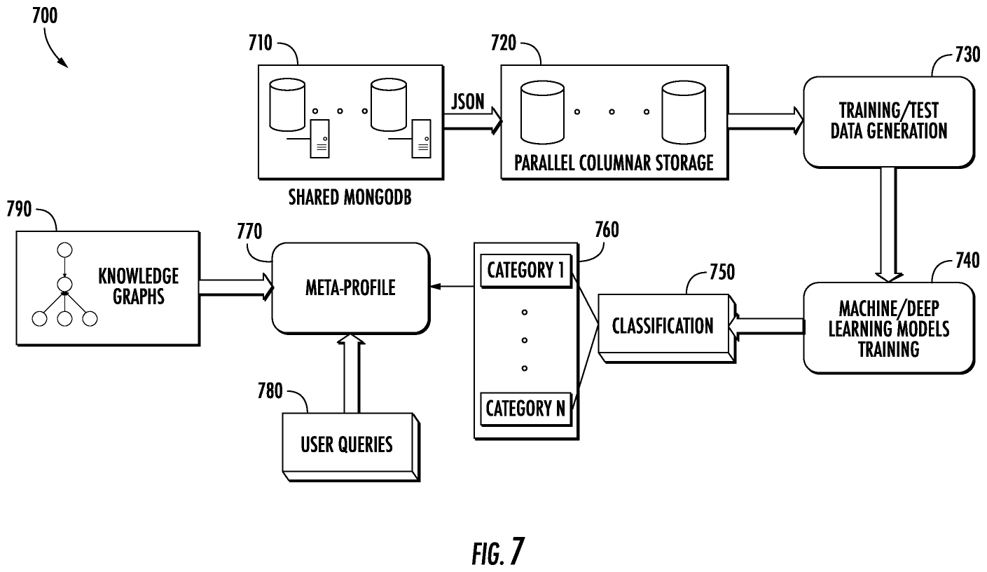

Referring now to FIG. 7, the COVIDKG back-end architecture consists of a shared MongoDB JSON storage 710 [9] that holds more than 450,000 publications on COVID-19 from CORD-19 as well as other sources, parsed into JSON and sent to a secondary storage 720, e.g., a parallel columnar storage. The data is used in training of test data generation 730 before being used in training the machine learning/deep learning models 740. The data is then used in classification 750, where the classifications are grouped 760 then added to the meta-profile 770. The back-end architecture operates to enrich the meta-profiles with different classified characteristics by the Deep-Learning models, running non-stop, classifying new incoming publications. The meta-profile 770 is accessible by user queries 780 and used by knowledge graphs 790.

The user-facing component of the COVIDKG system is the interactive Knowledge Graph front-end graphical Web interface. The Web interface displays and allows convenient interaction with the hierarchical structure of nodes and edges that display valuable information learned from the CORD-19 dataset as well as vetted information from other reputable COVID-19 API resources. COVIDKG also hosts several custom search engines to process complex queries and retrieve more detailed information from the original publications. COVIDKG releases hundreds of pre-trained models and embeddings as an API for reuse by data scientists and developers.

Datasets: One of the datasets that the COVIDKG system utilizes is CORD19—an open research dataset [79], which adheres to high academic peer-review trustworthiness and relevance standards that public health informatics require. COVID-19 Research Dataset (CORD-19) was put together by the Office of Science and Technology Policy in the White House, along with six other institutions. Their goal was to revolutionize modern medicine by encouraging researchers with proper access to a vetted dataset to develop question-answering systems for progression in significant COVID-19 discoveries. Enabling the general public access to text and data mining on research articles without violating the rights of the authors. During its first few months more than 3,500 new publications were updated per week. This dataset has had continuous growth with new publications from the top major publishers in medicine and has grown to over 450,000 open-access publications [79].

Storage: The MongoDB [9] sharded cluster storing data and all trained Deep-learning models and embeddings takes ≈965 GB for its distributed dataset storage, with raw space consumption of more than 5 TB.

Advanced Search-engines. COVIDKG hosts several advanced search engines. The purpose of these search engines is to enable anyone from scientists to researchers and even to general public users, to have access to the latest cutting-edge information on COVID-19 and related scientific research. Three different search engines are currently provided for different types of structural queries. All three have a similar evaluation process but produce different sets of results. Each one allows for exact match of the query if wrapped in quotes or stemming match capability on a tokenized query. The Search Engine receives results from the database by using an aggregation query that passes the data through a series of pipeline stages. The first stage in the pipeline is a “$match” expression. It allows the developer to specify a condition to filter the dataset to pass on to the next stage in the pipeline. The “$match” pipeline stage utilizes text-based search through regular expressions that are stemmed from the root users searched terms.

The “$match” stage was used first to minimize the amount of data being passed through all the latter stages, thus significantly increasing performance and response time to the user. In the next stage, the data is passed through a “$project” stage, which streams only the specified fields to the next stage of the aggregation pipeline. Only specified fields that were necessary for carrying out calculations were printed on the screen. By removing unnecessary fields that take up space and time passing through each proceeding stage the system's performance was significantly improved. The pipeline also uses several custom “$function” stages to derive calculations based on the individual documents and the searched query for ranking results. These custom functions are written in JavaScript inside of MongoDB aggregation pipeline query. Once the aggregation is finished the results are paginated as a list of ten per page displaying brief snippets of the document and access to the full text. The ranking is an accumulation of various weighted features per document, such as the number of matches, proximity between the matched terms and which field the term was matched in. Each term in the corpus has an associated Term Frequency-Inverse Document Frequency (TF-IDF) weight in order to reward more important terms. For each matched term, its TF-IDF is weighted in the ranking per document.

Search over Paper Title, Abstract, Caption. This search engine has three search fields for title, abstract and table captions. The search fields are inclusive in the search results, meaning, if a user searches on a field there must be a document that matches at least one term in that field or it does not get passed on to the next stage regardless of if there are matches over the other fields. The results are formatted with table captions first, the title and authors and the full abstract.

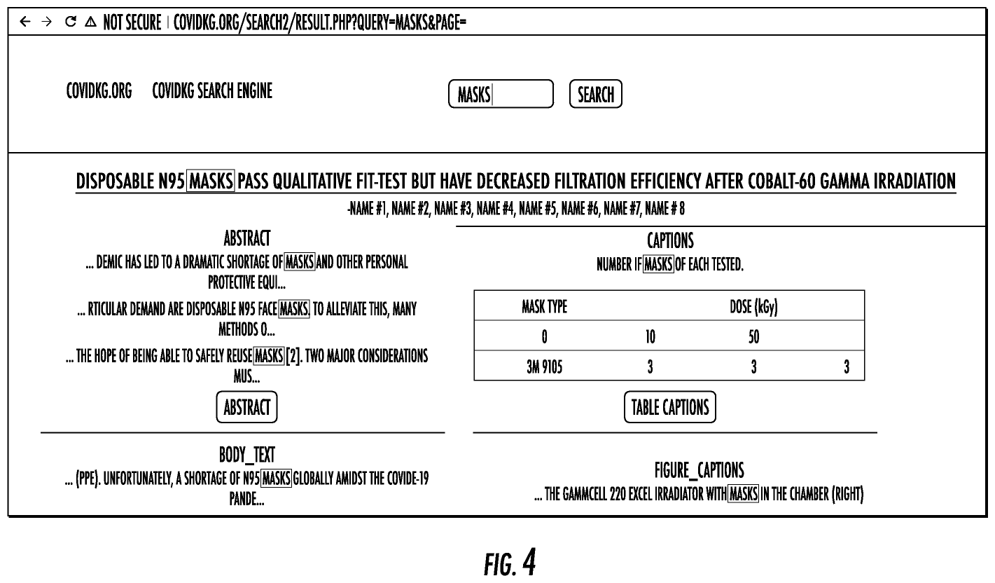

Search over all Publication Fields. If the user is unsure of where exactly the term may be or where the term is referenced is unimportant to the results then search over all fields is a good fit. As shown in FIG. 4, which depicts a screenshot of results where a user queried for “masks”. These results are formatted with a brief excerpt of where it matches in abstract, body text, table captions, tables and figure captions. The interface also allows the user to expand and collapse appropriately.

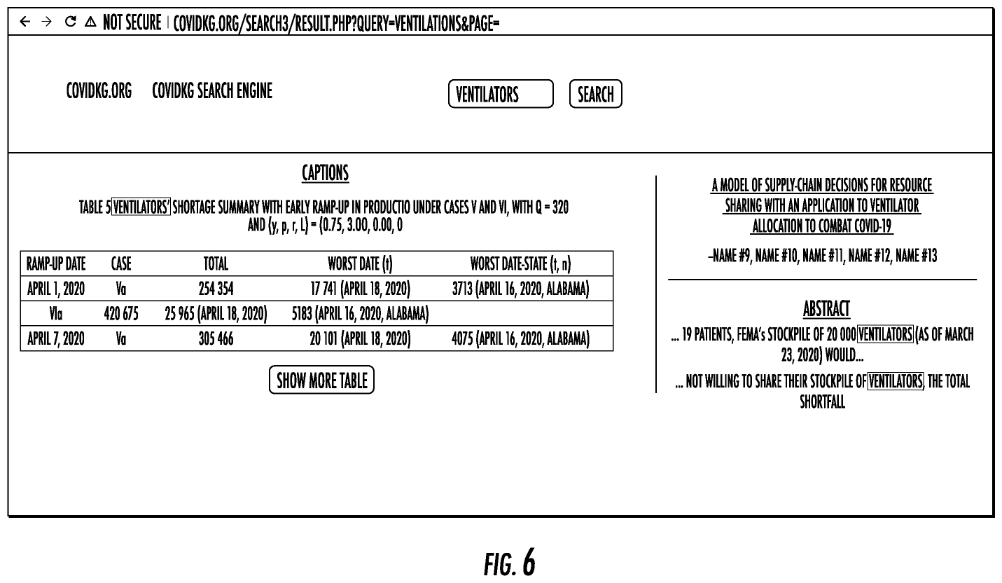

Search over Paper Tables. Search capability over tables is a large part of the system's advanced structural information retrieval. These search results are a product of regular expression search over table captions and all of the table's data and are displayed, as shown in FIG. 6, which depicts a screenshot of search results from a user query “ventilators” and displays results where ventilators matched the tables. The display highlights the matched term for every field. As shown, there is a match at the first table and the abstract. Additional search results may be included in the display, such as search results, which are ranked with an advanced ranking function having both static and dynamic features. Each field displays a brief view of the matches and allows the user to expand and collapse, respectively.

### Metadata Classification:

Hardware: Training and validating of some models were done on a cluster of 4 machines, each having 4 Intel Xeon 2.4 Ghz 40-core CPUs, from 192 GB to 1 TB of RAM, with 10 TB disk space each, interconnected with a 1 GB Ethernet. All software was written in the Python programming language. For implementing the RNN model, Keras was used, with Tensorflow framework as the backend. The SVM classifier was implemented using Scikit-learn, a popular machine learning library for python.

CORD-19. The COVID-19 Open Research Dataset (CORD-19)[79] is an extraction of scientific papers on COVID-19 [79]. In addition to the paper's fields (i.e., authors, title, abstract), it also contains raw metadata. An additional HTML table parser and post-processor were developed that takes raw HTML fragments from CORD-19 and converts them to semi-structured, clean JSON[66] format.

Feature space. Approximately 100,000-dimensional feature space were used, i.e. 100K English terms in the vocabulary that were selected by taking all terms from the datasets, sorting by frequency and cutting off the noise words and spam [78]. Increasing the dimensionality further led to significantly slower training time, which would prevent or make the experiments much more computationally expensive.

Evaluation. The training sets were composed of Web-scale datasets such as WDC and CORD-19 respectively [79]. The models were evaluated and 89%-96% F-measure was observed on average respectively, when validated with 10-fold cross-validation, for Machine-learning-based model (SVM [63]) and Deep-learning Bi-GRU-based models with slight differences depending on whether the classified metadata is horizontal or vertical, as well as its row/-column number.

Pre-processing. To streamline the processing of numerical data processed by the model, several regular expressions were created that encode all numerical data falling in similar forms under its relevant category. The substitution is done as follows:

All the Zeros in both decimal and integer forms in the data are substituted with “ZERO.” The order of these expressions is important as 0 in 50 is not the same as 0.0. The data in the form of arithmetic ranges like 5-10 mg, is replaced with the keyword “RANGE”, However, we have not replaced the units following the range as they are parsed in a later part of the method. The magnitude of data in the dataset is not uniformly spread. A large part of data is the numbers valued less than 0, so these numbers of different magnitudes were divided into three parts. The negative integers are replaced with NEG, this expression only takes negative numbers and not the words/ranges with—in them. The numbers less than 0 are replaced with “SMALLPOS”. The numbers greater than 0 are further divided into two parts, “FLOAT” and “INT”, these numbers have no limit and are not further binned. No patterns were observed in potential upper limits. After having substituted all numbers, symbols, units, and operators are left. The symbol % was replaced with “PERCENT.” Note that 5% and 0.5% were not replaced the same way; the respective substitutions were “SMALLINT PERCENT” and “INT PERCENT”. The dates of the form where month is represented in words are substituted with “DATE,” and dates of the form mm/dd/yy, were not accepted. Symbols < and > are substituted with “LESS” and “GREATER” keywords, respectively. The most frequently occurring units were Time, ml, mg, and kg which were substituted with the integers followed by these units in their respective descriptive keywords.

New Positional Features. The feature vector was constructed by calculating new positional features from each row of the table. These feature vectors were used for the SVM model [63]. The feature vector consisted of seven features {f₁, f₂, . . . , f₇} where f₁ is a data or metadata row with valid numerical substitutions as described in the pre-processing step, f₂ is the number of cells in the table row, f₃ is a binary value conforming if the above row exists for the current row, f₄ is a binary value conforming the above row below exists for the current row, f₅ equals to the total number of cells in the row above, f₆ equals to the total number of cells in the below row, f₇ is a Boolean label indicating if it is a metadata row (NULL for the training instances). {f₃, . . . , f₇} all the features collectively are called positional features. Each feature affects the metadata classification outcome.

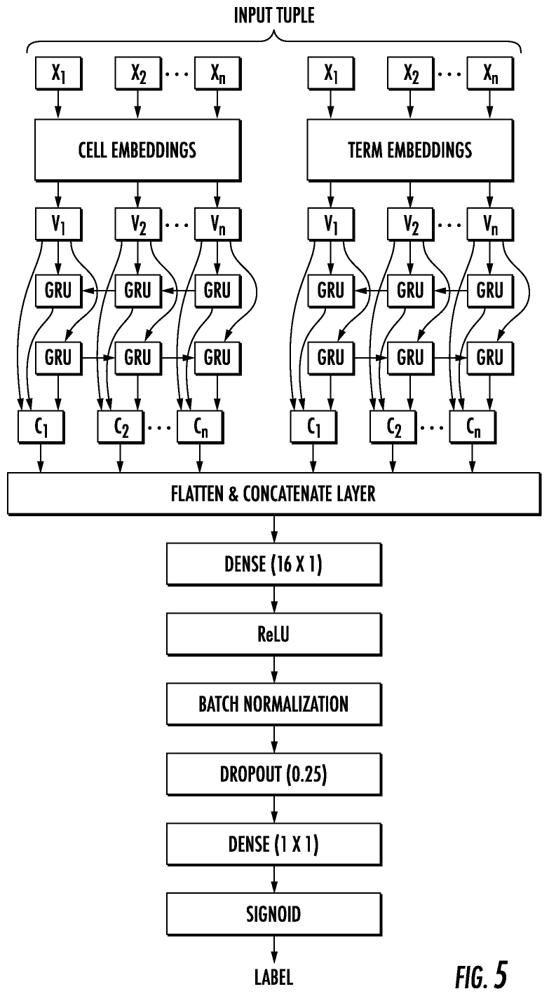

BiGRU Ensemble with parallel Embedding Layers. FIG. 5 depicts the architecture of a BiGRU ensemble consisting of three main stages. In the first stage, a data or metadata tuple, {x₁, x₂, . . . , xₙ}, where xᵢ is the i^{th} term from the tuple, was preprocessed to create both cell-wise and term-wise representations. It includes data cleaning along with the replacement of numbers and ranges in data with placeholders such as “NUM,” “RANGE”, etc. as was described above for the Machine-learning model. The preprocessed feature vectors were then used to train Word2Vec embeddings on the whole corpus (e.g., pre-trained on WDC and CORD-19 and then fine-tuned with end-to-end training on the target corpus). The model runs along both inputs in parallel, converting them into their respective pre-trained embedding vectors, {v₁, v₂, . . . , vₙ}. This sequence was passed through a BiGRU layer with one hundred BiGRU units and the result was concatenated with the original embeddings to create enriched contextualized vectors, {c₁, c₂, . . . , cₙ}. The output of each path was flattened to create both cell- and term-wise tuple representations. The final stage of the model concatenated the two representations and passed them through a dense layer of sixteen units, a batch normalization layer, a dropout layer and a dense binary classifier.

Since tuples in tables are order independent and context specific, both global average pooling and traditional RNNs were ill-suited for creating good tuple representations. Because of this bidirectional RNNs (biLSTM and biGRU) were utilized, since are able to capture contextual dependencies by taking into account both forward and backward context [72]. This not only reduced the effect of order dependence inherent to traditional RNNs but also captured the context specific information that was lost in averaging over the static word embeddings, [52]. The biGRU layers were chosen over biLSTM because while performance was slightly worse, with −0.02 ΔF1−Score, −0.7 ΔPrecision, +0.06 ΔRecall, the training time was faster. Concatenating the original embeddings with their context specific representations allowed the model to additionally account for global correlation when making predictions.

### Knowledge Graph:

Initialization. The structural hierarchy (i.e. nodes and edges) for the Knowledge Graph was initialized with the help of a Medical expert (101 of FIG. 1). On the highest level, the general characteristics of COVID-19 as a virus were extracted from older, vetted ontologies about viral infections, e.g., symptoms, ways of transmission, etc. Once initialized, the KG automatically updated from the vetted medical sources. This ensures reliability, freshness, and quality of the KG (i.e., 102 of FIG. 1).

Enrichment and Fusion. Once the KG initialization was completed, the extracted information was fused into the Knowledge Graph during the enrichment process. The clusters prominent COVID-19 topics were classified and extracted (e.g., 105 of FIG. 1). This process was challenging since all topical clusters have different structure and significant concepts and terms can be referred to differently (e.g., COVID-19 and coronavirus disease 2019). Consequently, a variety of advanced AI models were trained with the tabular embeddings to help perform accurate clustering [30, 57].

The graph was populated with nodes and edges and was stored in JSON format. The structure of the graph was hierarchical, so all child nodes have parent nodes. The user was able to search over the KG via the front-end interface that, except for matching nodes, also highlights the path to the matching nodes. The user was able to either browse the graph to explore the structure starting from the matching nodes or click the papers linked off these nodes to read about the topic of preference in more detail.

Fusion of the extracted hierarchical knowledge into a segment or several segments of the KG required consideration of multiple levels of abstraction. For example, “Symptoms” could be a node in a subtree “Clinical presentation” that could be, in turn, linked to the “COVID-19” KG root node.

Because of the different ways to categorize, the actual symptoms may overlap in different KG subtrees. After consulting with several medical experts, it was decided to store all different ways to categorize the data without merging them, since each of the categorization methods can be useful for different kinds of users and medical specialists. While the general public might be interested in common and rare symptoms, medical specialists might analyze specific organ systems. For example, sorting by “rare symptoms” and “common symptoms” can overlap with the sets of symptoms sorted by “organ systems.” In addition to that, even though “Neurological symptoms” are related to the nervous system in general, while “Cerebrovascular” is related to the brain and its blood vessels, they have significant overlap in symptoms.

The first step of fusing the extracted hierarchical knowledge into the KG was matching the root node of the extracted subtree to the corresponding node(s) in the KG. This matching process was based on normalized NLP term matching, amended by the embedding-driven matching. The latter was especially important in context of new terms, unseen before, which was often the case with new vaccines, viral strands, etc. For example, assume a subtree was extracted, Vaccine→NovoVac, from the table's metadata. The root node Vaccine may match to the KG node Vaccine(s) by normalized NLP term matching and then the leaves (NovoVac) can be merged with the leaves of the matched node in the KG. However, if there is no corresponding KG node Vaccine(s) and there is no match to the KG leaves with existing vaccines, the embedding vector corresponding to the new vaccine (NovoVac) extracted from metadata can be used to match it to the embeddings vectors of the existing vaccines in the KG due to them being close to each other by distance. The node Vaccine then can be added to the KG on the top of the NovoVac node.

If the extracted subtree has several layers of hierarchy, e.g., Side-effects→Children side-effects→Rash, Rash was left separate from the existing side-effects in the KG, even if matched to them by having close embedding vectors. This is because, it was categorized as Children's side-effects, which was a separate category from regular side-effects, so both the new node Children's side-effects and its leaves have to be added to the KG, even if some of the side-effects overlap with the general side-effects, already present in the KG. Fusion of sub-trees, having several layers or insertion of new nodes were evaluated by a human expert (114 of FIG. 1); fusion of leaves with nodes matched with high confidence score were left unsupervised in some instances. Over time, all categories of initial fusion mistakes identified by the expert were learned by the fusion module to be automatically corrected, hence most of the fusion became minimally supervised.

Discussion: The disclosed COVIDKG system was used to automatically construct and refresh a Scientific Knowledge Graph (KG) having all latest trustworthy, vetted medical knowledge. Having had it operational before and during the COVID-19 pandemic could have been game changing for society. It can help during any future pandemics as well—be it Monkeypox, Polio, Zika, Ebola, or a new unknown virus.

Currently existing, socially maintained KGs such as YAGO [70], DBPedia [19] or medical ontologies, such as NCBI, Viral [8], COVID-19 [2] and others are static, hence the KG are become outdated and obsolete. Manually curated popular resources such as CDC.gov and WebMD.com are updated more frequently but are very high-level and can afford to cover only the most dominating topics due to high updating cost. Resources such as covidgraph.org [10] focus on a set of very narrow topics in COVID-19 genetics, merged with older SwissProt, Gene Ontology ontologies. They have slightly deeper knowledge but are limited to very narrow subtopics. By contrast, the disclosed Deep-learning (DL) architecture, capable of constructing and refreshing the Web-scale KG on demand for a given domain exhibits both broad topical coverage within the domain, as well as depth within each topic. Here, COVID-19 was the model, but without making the architecture depend on it, so the overall approach remains truly “on demand”—i.e., applicable to other scientific areas.

The COVIDKG system bridges the gap between shortcomings of state-of-the-art solutions of trustworthiness and case of comprehension [17, 54, 55, 57-59, 78]. It does so by coupling the user-friendly KG interface with the actively maintained and interrogated for bias training datasets, full of new vetted, medical research findings [79].

[6] is an Information Retrieval (IR) system over publications at researchrabbit.ai. A retrieval mechanism was introduced over papers that does not require the use of keyword-search. A force directed graph of related, cited and referenced papers are displayed that a user can construct and use. Many features are provided, such as customizable graphs of papers, curated collections to improve recommendations, personalized alerts, sharing and collaborating of papers and graphs, and among others the ability to discover author networks.

Another system authored by the Center for Artificial Intelligent Research, HKUST ([1]), CAIRE-COVID, aims to provide a resource for solutions to the coronavirus disease by using a Machine learning based system that utilizes NLP question answering techniques along with the summarization to help discover available scientific literature. The system is comprised of three modules. The pipeline begins with a user query sent through the first module document retrieval, which paraphrases and searches. Query paraphrasing converts the user query to several shorter and simpler analogous questions. The search engine takes advantage of Anscrini and Lucene to retrieve related publications. Then the snippet selector module finds the related evidence among the whole text by using answer re-ranking, and term matching scores. Finally, a “Multi-document abstractive summarizer” that synthesizes the answer from multiple retrieved snippets steps in and generates a final answer.

Another relevant system [7], Sinequa has access to a COVID-19 Intelligent Insight portal of over 100,000 curated scientific publications. Sinequa's search engine supports full-text search using NLP. The Search engine supports ranking by relevance and recognizes synonymy in their ranking function. It has three sections. One for matching scientific results, one for showing more details on a selected result and the last one for filtering and sorting the result set. The system highlights important information throughout each result and tags them all by different classification labels.

An information retrieval resource for Covid-19 and related scientific research, COVIDScholar [3], was established by Matscholar's research effort. COVIDScholar uses NLP to empower search over a COVID-19 related dataset. The search results are matched by title, abstract, and keywords. COVIDScholar displays title, authors, and abstract, while providing a link to the full-text at its original publisher and a list of related works. They neither have a KG, nor an advanced search.

Public GraphQL APIs [4] and include a KG that is populated from certain classic, well-known ontologies such as NCBI, UniProt and other sources. The graph has information on genes of interest, transcripts, protein identifier's function names and gene names from many different resources.

COVIDKG provides several advanced search-engines over COVID-19 scientific resources. The user can either search the KG, or over all sections of the original publication, just the title, abstract, table captions, or table data. The search-results page provides a list of ranked scientific resources with access to each full-text of each section of the paper, full-text of the whole document, and ranked tables with the most relevant results. The ranking function incorporates matching terms and synonyms, proximity, document, terms, and publication weights, as well as many others. COVIDKG classifies documents by related topics enabling the data to be further categorized. The advanced search engine over tables displays a brief section with the most relevant tables first that can be expanded to see more results. The COVIDK Knowledge Graph is a complex interactive hierarchical data structure fused from all relevant research results found in a rich, curated corpus of scientific resources. The KG is trustworthy as it is built only from the vetted knowledge. It supports interactive search through paths of nodes that allows complex insights into the provenance of the search result. The nodes along the path provide access to the publications, where the result is coming from.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### REFERENCES

[1] [n.d.]. CAiRE-COVID.
[2] [n.d.]. The COVID-19 Infectious Disease Ontology. https://www.ebi.ac.uk/ols/ontologies/idocovid19.
[3] [n.d.]. COVIDScholar. https://covidscholar.org/stats
[4] [n.d.]. HealthECCO. https://healthecco.org/covidgraph/
[5] [n.d.]. online: http://www.recordedfuture.com. http://www.recordedfuture.com
[6] [n.d.]. researchrabbit. https://www.researchrabbit.ai/.
[7] [n.d.]. Sinequa. https://covidsearch.sinequa.com/app/covid-search/#/home
[8] [n.d.]. The Virus Infectious Disease Ontology. https://www.ebi.ac.uk/ols/ontologies/vido.
[9] 2007. online: http://www.mongodb.com. http://www.mongodb.com
[10] 2022. online: Helathecco medical graph. Healthecco.org/covidgraph/
[11] 2022. online: The National Science Foundation's Innovation Corps (I-Corps™) program. https://www.nsf.gov/news/special_reports/i-corps/
[12] Martín Abadi. 2015. TensorFlow: Large-Scale Machine Learning on Heterogeneous Systems. http://tensorflow.org/Software available from tensorflow.org.
[13] Zia Abedjan, John Morcos, Michael Gubanov, Ihab F. Ilyas, Michael Stonebraker, Paolo Papotti, and Mourad Ouzzani. 2014. DATAXFORMER: Leveraging the Web for Semantic Transformations. In CIDR.
[14] Eugene Agichtein and Luis Gravano. 2000. Snowball: Extracting Relations from Large Plain-Text Collections. In ACM DL. citeseer.ist.psu.edu/agichtein00snowball.html
[15] E. Agichtein, P. Ipeirotis, and L. Gravano. 2003. Modeling query-based access to text databases. citeseer.ist.psu.edu/agichtein03modeling.html
[16] Bogdan Alexe, Michael Gubanov, Mauricio A. Hernández, C. T. Howard Ho, Jen-Wei Huang, Yannis Katsis, Lucian Popa, Barna Saha, and Ioana Stanoi. 2008. Simplifying Information Integration: Object-Based Flow-of-Mappings Framework for Integration. In BIRTE.
[17] Bogdan Alexe, Michael Gubanov, Mauricio A. Hernandez, Howard Ho, Jen-Wei Huang, Yannis Katsis, and Lucian Popa. 2009. Simplifying Information Integration: Object-Based Flow-of-Mappings Framework for Integration. In Business Intelligence for the Real Time Enterprise. Springer.
[18] Michael Armbrust, Reynold S. Xin, Cheng Lian, Yin Huai, Davies Liu, Joseph K. Bradley, Xiangrui Meng, Tomer Kaftan, Michael J. Franklin, Ali Ghodsi, and Matei Zaharia. 2015. Spark SQL: Relational Data Processing in Spark. In Proceedings of the 2015 ACM SIGMOD International Conference on Management of Data (Melbourne, Victoria, Australia) (SIGMOD '15). ACM, New York, NY, USA, 1383-1394. https://doi.org/10.1145/2723372.2742797
[19] Sören Auer, Christian Bizer, Georgi Kobilarov, Jens Lehmann, Richard Cyganiak, and Zachary Ives. 2007. DBpedia: A Nucleus for a Web of Open Data. In ISWC'07/ASWC'07.
[20] Zohra Bellahsene, Angela Bonifati, and Erhard Rahm. 2011. Schema Matching and Mapping. In Springer.
[21] Michael J Cafarella, Alon Halevy, Daisy Zhe Wang, Eugene Wu, and Yang Zhang. 2008. Webtables: exploring the power of tables on the web. VLDB (2008).
[22] Michael J Cafarella, Dan Suciu, and Oren Etzioni. 2007. Navigating Extracted Data with Schema Discovery. In WebDB. Citescer.
[23] Anna May Lorenzo Polidori Joan Capdevila Panayiotis Louca et al Cristina Menni, Kerstin Klaser. 2021. Vaccine side-effects and SARS-COV-2 infection after vaccination in users of the COVID Symptom Study app in the UK: a prospective observational study.
[24] Google Developers. 2012. Google Knowledge Graph. https://developers.google.com/knowledge-graph.
[25] Jörg Diederich, Wolf-Tilo Balke, and Uwe Thaden. 2007. Demonstrating the semantic growbag: automatically creating topic facets for faceteddblp. In JCDL.
[26] AnHai Doan, Pradap Konda, Paul Suganthan G. C., Yash Govind, Derek Paulsen, Kaushik Chandrasekhar, Philip Martinkus, and Matthew Christie. 2020. Magellan: toward building ecosystems of entity matching solutions. CACM (2020).
[27] Xin Luna Dong, Barna Saha, and Divesh Srivastava. 2013. Explaining data fusion decisions. In WWW.
[28] D. Downey, O. Etzioni, S. Soderland, and D.S. Weld. 2004. Learning text patterns for Web information extraction and assessment. In AAAI. citeseer.ist.psu.edu/agichtein03modeling.html
[29] Christiane Fellbaum (Ed.). 1998. WordNet: An Electronic Lexical Database (Language, Speech, and Communication). The MIT Press.
[30] Anna Lisa Gentile, Petar Ristoski, Steffen Eckel, Dominique Ritze, and Heiko Paulheim. 2017. Entity Matching on Web Tables: a Table Embeddings approach for Blocking. In EDBT.
[31] Yash Govind, Pradap Konda2, Paul Suganthan G. C., Palaniappan Nagarajan, Han Li, Aravind Soundararajan, Sidharth Mudgal, Jeffrey R. Ballard, Haojun Zhang, Adel Ardalan, Sanjib Das, Derek Paulsen, Amanpreet Saini, Erik Paulson, Youngchoon Park, Marshall Carter, Mingju Sun, Glenn M. Fung, and AnHai Doan. 2019. Entity Matching Meets Data Science: A Progress Report from the Magellan Project. In SIGMOD.
[32] Michael Gubanov. 2017. Hybrid: A Large-scale In-memory Image Analytics System. In CIDR.
[33] Michael Gubanov. 2017. Polyfuse: A large-scale hybrid data fusion system. In ICDE.
[34] M. Gubanov, C. Jermaine, Z. Gao, and S. Luo. 2016. Hybrid: A Large-scale Linear-relational Database Management System. In MIT NEDB.
[35] Michael Gubanov, Chris Jermaine, Zekai Gao, and Shangyu Luo. 2016. Hybrid: A Large-scale Linear-relational Database Management System. In MIT Annual DB Conference.
[36] Michael Gubanov, Manju Priya, and Maksim Podkorytov. 2017. CognitiveDB: An Intelligent Navigator for Large-scale Dark Structured Data. In WWW.
[37] Michael Gubanov and Anna Pyayt. 2012. MedReadFast: Structural Information Retrieval Engine for Big Clinical Text. In IRI.
[38] M. Gubanov and A. Pyayt. 2013. ReadFast: High-relevance Search-engine for Big Text. In ACM CIKM.
[39] M. Gubanov and A. Pyayt. 2014. Type-aware Web search. In EDBT.
[40] Michael Gubanov, Anna Pyayt, and Sophie Pavia. 2022. Visualizing and Querying Large-scale Structured Datasets by Learning Multi-layered 3D Meta-Profiles. In BigData. IEEE.
[41] M. Gubanov, A. Pyayt, and L. Shapiro. 2011. ReadFast: Browsing large documents through UFO. In IRI.
[42] Michael Gubanov and Linda Shapiro. 2012. Using Unified Famous Objects (UFO) to Automate Alzheimer's Disease Diagnostics. In BIBM.
[43] Michael Gubanov, Linda Shapiro, and Anna Pyayt. 2011. Learning Unified Famous Objects (UFO) to Bootstrap Information Integration. In IRI.
[44] M. Gubanov and M. Stonebraker. 2014. Large-scale Semantic Profile Extraction. In EDBT.
[45] M. Gubanov and M. Stonebraker. 2014. Text and Structured Data Fusion in Data Tamer at Scale. In ICDE.
[46] Michael N. Gubanov and Philip A. Bernstein. 2006. Structural text search and comparison using automatically extracted schema. In WebDB.
[47] Michael N. Gubanov, Philip A. Bernstein, and Alexander Moshchuk. 2008. Model Management Engine for Data Integration with Reverse-Engineering Support. In ICDE.
[48] A. Halevy. 2013. Data Publishing and Sharing using Fusion Tables. In CIDR.
[49] Joseph M. Hellerstein, Christopher Re, Florian Schoppmann, Daisy Zhe Wang, and Eugene Fratkin. 2012. RuleMiner: Data quality rules discovery. In PVLDB.
[50] Zhiheng Huang, Wei Xu, and Kai Yu. 2015. Bidirectional LSTM-CRF Models for Sequence Tagging. arXiv. https://doi.org/10.48550/ARXIV.1508.01991
[51] Kazi Islam and Michael Gubanov. 2021. Scalable Tabular Metadata Location and Classification in Large-scale Structured Datasets. In DEXA.
[52] L. C. Jain and L. R. Medsker. 1999. Recurrent Neural Networks: Design and Applications (1st ed.). CRC Press, Inc., USA.
[53] Karen Sparck Jones. 1972. A statistical interpretation of term specificity and its application in retrieval. Journal of Documentation 28 (1972), 11-21.
[54] Rituparna Khan and Michael Gubanov. 2018. Nested Dolls: Towards Unsupervised Clustering of Web Tables. In IEEE Big Data.
[55] Rituparna Khan and Michael Gubanov. 2018. Towards Unsupervised Web Tables Clustering. In IEEE BigData.
[56] Rituparna Khan and Michael Gubanov. 2020. Towards Tabular Embeddings, Training the Relational Models. In IEEE Big Data.
[57] Rituparna Khan and Michael Gubanov. 2020. WebLens: Towards Interactive Large-Scale Structured Data Profiling. In CIKM.
[58] Rituparna Khan and Michael Gubanov. 2020. WebLens: Towards Interactive Web-scale Data Integration, Training the Models. In IEEE Big Data.
[59] Anusha Kola, Harshal More, Sean Soderman, and Michael Gubanov. 2017. Generating Unified Famous Objects (UFOs) from the classified object tables. In IEEE Big Data.
[60] A. Laender, B. Ribeiro-Neto, A. Silva, and J. Teixeira. 2002. A Brief Survey of Web Data Extraction Tools. In SIGMOD Record. citescer.ist.psu.edu/laender02brief.html
[61] Oliver Lehmberg, Dominique Ritze, Robert Meusel, and Christian Bizer. 2016. A Large Public Corpus of Web Tables containing Time and Context Metadata. In WWW, Jacqueline Bourdeau, Jim Hendler, Roger Nkambou, Ian Horrocks, and Ben Y. Zhao (Eds.).
[62] Girija Limaye, Sunita Sarawagi, and Soumen Chakrabarti. 2010. Annotating and Searching Web Tables Using Entities, Types and Relationships. (2010).
[63] Hsuan-Tien Lin and Chih-Jen Lin. 2003. A Study on Sigmoid Kernels for SVM and the Training of non-PSD Kernels by SMO-type Methods. Technical Report. Department of Computer Science and Information Engineering, National Taiwan University, Taipei, Taiwan.
[64] Reid McMurry, Patrick Lenchan, Samir Awasthi, and et al. 2021. Real-time analysis of a mass vaccination effort confirms the safety of FDA-authorized mRNA vaccines for COVID-19 from Moderna and Pfizer/BioNtech. medRxiv.
[65] Sutskever I. Chen K. Corrado G. S. Dean J Mikolov, T. 2013. Distributed representations of words and phrases and their compositionality. In NIPS.
[66] Steven Ortiz, Caner Enbatan, Maksim Podkorytov, Dylan Soderman, and Michael Gubanov. 2017. Hybrid.JSON: High-velocity Parallel In-Memory Polystore JSON Ingest. In IEEE Bigdata.
[67] Sophie Pavia, Rituparna Khan, Anna Pyayt, and Michael Gubanov. 2022. Simplifying Access to Large-scale Structured Datasets by Meta-Profiling with Scalable Training Set Enrichment. In SIGMOD. ACM.
[68] Sophie Pavia, Nick Piraino, Kazi Islam, Anna Pyayt, and Michael Gubanov. 2022. Hybrid Metadata Classification in Large-scale Structured Datasets. J. Data Intell. 3, 4 (2022).
[69] Sophie Pavia, Montasir Shams, Rituparna Khan, Anna Pyayt, and Michael N. Gubanov. 2021. Learning Tabular Embeddings atWeb Scale. In Big Data. IEEE.
[70] Thomas Pellissier Tanon, GerhardWeikum, and Fabian Suchanek. 2020. YAGO 4: A Reason-able Knowledge Base. In ESWC, Andreas Harth, Sabrina Kirrane, Axel-Cyrille Ngonga Ngomo, Heiko Paulheim, Anisa Rula, Anna Lisa Gentile, Peter Haase, and Michael Cochez (Eds.).
[71] Maksim Podkorytov and Michael N. Gubanov. 2018. Hybrid.Poly: Performance Evaluation of Linear Algebra Analytical Extensions. In IEEE Big Data.
[72] Rajib Rana. 2016. Gated Recurrent Unit (GRU) for Emotion Classification from Noisy Speech.
[73] Abanoub Riad, Andrea Pokorná, and Samch Attia et al. 2021. Prevalence of COVID-19 Vaccine Side Effects among Healthcare Workers in the Czech Republic, Vol. 10. JCIMed.
[74] Montasir Shams, Sophie Pavia, Rituparna Khan, Anna Pyayt, and Michael N. Gubanov. 2021. Towards Unveiling Dark Web Structured Data. In Big Data. IEEE.
[75] Mark Simmons, Daniel Armstrong, Dylan Soderman, and Michael Gubanov. 2017. Hybrid.media: High Velocity Video Ingestion in an In-Memory Scalable Analytical Polystore. In IEEE Bigdata.
[76] Amit Singhal. 2012. Introducing the KG: Things, Not Strings. In Google Blog.
[77] Sean Soderman, Anusha Kola, Maksim Podkorytov, Michael Geyer, and Michael Gubanov. 2018. Hybrid.AI: A Learning Search Engine for Largescale Structured Data. In WWW.
[78] Santiago Villasenor, Tom Nguyen, Anusha Kola, Sean Soderman, and Michael Gubanov. 2017. Scalable spam classifier for web tables. In IEEE Big Data.
[79] Lucy Lu Wang, Kyle Lo, Yoganand Chandrasekhar, Russell Reas, Jiangjiang Yang, Doug Burdick, Darrin Eide, Kathryn Funk, Yannis Katsis, Rodney Kinney, Yunyao Li, Ziyang Liu, William Merrill, Paul Mooney, Dewey Murdick, Devvret Rishi, Jerry Sheehan, Zhihong Shen, Brandon Stilson, Alex Wade, Kuansan Wang, Nancy Xin Ru Wang, Chris Wilhelm, Boya Xie, Douglas Raymond, Daniel S. Weld, Oren Etzioni, and Sebastian Kohlmeier. 2020. CORD-19: The COVID-19 Open Research Dataset. In arXiv, cs.DL 2004.10706.
[80] Nasser Zalmout, Chenwei Zhang, Xian Li, Yan Liang, and Xin Luna Dong. 2021. All You Need to Know to Build a Product Knowledge Graph. In SIGKDD, Feida Zhu, Beng Chin Ooi, and Chunyan Miao (Eds.). ACM.

What is claimed:

1. A method for automatically constructing knowledge graphs comprising:
accessing a dataset, the dataset comprising a plurality of articles related to a specific topic;
classifying, using a first artificial intelligence (AI) model, a plurality of tables within the dataset;
classifying, using a second AI model, a plurality of hierarchal metadata of the tables; and
fusing, using a third AI model, the hierarchal metadata into a knowledge graph, the knowledge graph being associated with the specific topic.

2. The method of claim 1, further comprising analyzing the dataset to parse and store content in a semi-structured format.

3. The method of claim 1, further comprising preprocessing the tables to encode numerical data within the tables.

4. The method of claim 3, further comprising constructing a plurality of feature vectors for each of a plurality of rows within the tables.

5. The method of claim 1, further comprising clustering, using a fourth AI model, the tables into a plurality of sub-topics associated with the specific topic.

6. The method of claim 1, further comprising initializing a structural hierarchy of the knowledge graph.

7. The method of claim 1, wherein the articles are peer-reviewed articles.

8. The method of claim 1, wherein the specific topic is COVID-19.

9. The method of claim 1, wherein the first AI model is a recurrent neural network (RNN), the second AI model is a support vector machine (SVM), and the third AI model is a natural language processing (NLP) model.

10. A method for providing a search engine comprising:
providing the knowledge graph of claim 1; and
providing a user interface for interrogating the knowledge graph.

11. The method of claim 10, further comprising receiving a user query at the user interface and displaying search results on the user interface.

12. A system for automatically constructing knowledge graphs comprising:
a computing cluster comprising a plurality of computing devices, each computing device comprising at least one processor and a memory operably coupled to the at least one processor;
a database operably coupled to the computing cluster, wherein the database stores a dataset comprising a plurality of articles related to a specific topic, wherein the computing cluster is configured to:
access the dataset;
classify, using a first artificial intelligence (AI) model, a plurality of tables within the dataset;
classify, using a second AI model, a plurality of hierarchal metadata of the tables; and
fuse, using a third AI model, the hierarchal metadata into a knowledge graph, the knowledge graph being associated with the specific topic.

13. The system of claim 12, wherein the computing cluster is further configured to analyze the dataset to parse and store content in a semi-structured format.

14. The system of claim 12, wherein the computing cluster is further configured to preprocess the tables to encode numerical data within the tables.

15. The system of claim 14, wherein the computing cluster is further configured to construct a plurality of feature vectors for each of a plurality of rows within the tables.

16. The system of claim 12, wherein the computing cluster is further configured to cluster, using a fourth AI model, the tables into a plurality of sub-topics associated with the specific topic.

17. The system of claim 12, wherein the computing cluster is further configured to initialize a structural hierarchy of the knowledge graph.

18. The system of claim 12, wherein the articles are peer-reviewed articles.

19. The system of claim 12, wherein the specific topic is COVID-19.

20. The system of claim 12, wherein the first AI model is a recurrent neural network, the second AI model is a support vector machine, and the third AI model is a natural language processing model.
